(19) United States
(12) Patent Application Publication
(10) Pub. No.: US 2014/0279106 A1
(43) Pub. Date: Sep. 18, 2014

(54) SYSTEM AND METHOD FOR ORGANIZING ELECTRONIC MOBILE PAYMENT TRANSACTIONS

(71) Applicant: MASTERCARD INTERNATIONAL INCORPORATED, (US)

(72) Inventor: Mark R. Smelcer, Ofallon, MO (US)

(73) Assignee: MASTERCARD INTERNATIONAL INCORPORATED, Purchase, NY (US)

(21) Appl. No.: 13/804,155

(22) Filed: Mar. 14, 2013

(51) Int. Cl. G06Q 20/36

(52) U.S. Cl. CPC G06Q 20/36
USPC 705/21; 705/41

(57) ABSTRACT

A system for organizing electronic mobile payment transactions using a mobile device that uses electronic payment systems utilizing a digital wallet to make payments to a vendor is provided. The vendor's POS system the payment network and the digital wallet have a plurality of components for generating a digital receipt for use by the mobile device. The system includes an apparatus for hosting the digital wallet; a first communication channel for communication of the location of the payer's digital wallet as the destination where the receipt shall be sent; a second communication channel for transmitting data concerning the purchase to the apparatus in a form useful to the apparatus so that the merchant generates the contents of a digital receipt that has data fields such that data can be stored for retrieval. The system also includes at least one application available to the mobile device that permits the data in the data fields to undergo data processing to be manipulated by a user of the mobile device for presentation on the mobile device.

### BACKGROUND OF THE DISCLOSURE

1. Field of the Disclosure

The present disclosure relates to a system and method for organizing electronic payment transactions during travel. More particularly, the present disclosure relates to a system and method for organizing electronic payment transactions during travel using a mobile device.

2. Description of the Related Art

Mobile and point of sale transactions are becoming very convenient for consumers and vendors. Recently, the introduction of the PayPass™ Wallet by MasterCard, the assignee of the present application, provides a free digital wallet service that makes point of sale (POS) and online shopping safe and easy by storing all payment and shipping information in one convenient and secure place. With PayPass™ Wallet, the consumer simply shops and checks out faster. During POS or on-line shopping from a home computer or mobile device, a customer can simply activate a digital wallet application by clicking on an icon for that application, and all information generally required to make a purchase is communicated to the merchant or vendor.

With the introduction of the Tabbedout™, consumers and vendors can communicate with various locations by simply carrying the handheld device. Tabbedout™ provides applications that are available for the iPhone and Android platforms, and partners with restaurants and other establishments to allow a user to pay for their bills via the designated application. Tabbedout™ allows a user to store credit card information directly on their phone, encrypted and under pass phrase protection, instead of on Tabbedout's host servers. When the user is ready to leave the establishment, the user selects the card they want and strikes the “pay” tab. Tabbedout™ encrypts name and credit card information and sends it electronically to the restaurant or establishment's POS system.

NFC (Near Field Communication) is a wireless technology that allows devices to communicate with each other over short distances. The electronic data transfer between the devices occurs over either short wave or using a touch or tap, via an app.

Square™ allows users to accept credit cards through their mobile phone, either by swiping the card on the Square device that attaches to the mobile phone or by manually entering the details on the phone.

As the number of such transactions increases by the consumer, managing purchases for the purpose of monitoring money flow and location becomes increasingly difficult.

There are a variety of ways in which vendors may provide assistance in the form of a receipt for a purchase. For example, when an order is placed with a merchant, at a POS, the e-mail receipt is often sent to the customer. This email may include information specifying the product or products ordered, the cost, the account that the customer used to make the payment, and other information relevant to the order. Whether the purchase is made online, in person or over the telephone, to receive such receipts, the customer must provide additional information during the transaction, which only adds to the burden of placing the transaction. Such receipts are in a variety of formats, and are not convenient for later accessing processing, analysis or manipulation.

Typical digital wallets may display transaction history, but do not provide specific information or visual summaries or cumulative analytics of the transactions or ordering receipts.

Credit card accounts may provide year end statements that show expenditures in various categories. This data is for a single credit card account, and does not organize the data based on a transaction associated with a specific trip. Also, such data may not be available for review at all desired times.

Mint.com, an online service, provides spending analysis based on bank accounts (bank, credit card) that the consumer has linked to the service, but do not provide SKU (stock keeping unit) level information customary in current paper or email receipts. Information can be provided on merchant category level (e.g. restaurants, gas stations, etc.).

TabbedOut™ mobile application displays a receipt when the tab at a restaurant or bar is closed, however, it has limitations as other receipts noted above.

Square™ allows a user to explore nearby businesses, browse store and menu information, and review transaction history, however it does not permit location of the individual restaurant or the addition of manual scans, or provide customization to take a picture or offer a tax-deductible indication.

While different applications of providing receipts or assisting a user with a credit card transaction in a restaurant using a mobile device, such as those noted above may be helpful, there is no organized way of receiving receipts, organizing such receipts or manipulating the information on such receipts to categorize expenses. There is also no such application that would enable taking pictures of the receipt, taking a video of the purchase, mapping to show where the transaction occurred or adding parental controls to manage dependent spending while using the mobile device.

### SUMMARY OF THE DISCLOSURE

The present disclosure provides a system and method for organizing electronic payment transactions made during trips while the user travels.

The present disclosure also provides a system and method for using a digital wallet and an application associated with a mobile device to receive, store, take a picture of, retrieve and analyze one or more digital receipts associated with one or more mobile transactions of one or more trips so that receipts associated with the one or more transactions can be edited, recorded, and categorized.

The present disclosure further provides a system and method that can record a video to memorialize the experience of a transaction, and map where the transaction occurred, such as in a restaurant, so that the location of such restaurant can be re-called for future visits or forwarded to friends.

The present disclosure yet further provides such a system and method that has data fields associated with the digital receipt for a transaction that permit such information from the receipt to be edited, changed to a different category, and to indicate if the transaction is tax deductible.

A system for organizing electronic mobile payment transactions using a mobile device that uses electronic payment systems utilizing a digital wallet to make payments to a vendor is provided. The vendor's POS system the payment network and the digital wallet have a plurality of components for generating a digital receipt for use by the mobile device. The system includes an apparatus for hosting the digital wallet; a first communication channel for communication of the location of the payer's digital wallet as the destination where the receipt shall be sent; a second communication channel for transmitting data concerning the purchase to the apparatus in a form useful to the apparatus so that the merchant generates the contents of a digital receipt that has data fields such that data can be stored for retrieval. The system also includes at least one application available to the mobile device that permits the data in the data fields to undergo data processing to be manipulated by a user of the mobile device for presentation on the mobile device.

A method for organizing electronic mobile payment transactions using a mobile device that uses electronic payment systems utilizing a digital wallet to make payments to a vendor is provided. The vendor's POS system the payment network and the digital wallet have a plurality of components for generating a digital receipt for use by the mobile device. The method includes transmitting to an apparatus that hosts a digital wallet, data concerning a purchase in a form so that the merchant generates a digital receipt content, wherein the digital receipt has data fields that permit the digital receipt to be stored for retrieval. The method also includes by using the mobile device, manipulating data from the data fields using at least one application available to the mobile device that permits the data in the data fields to be selectively re-organized for presentation on the mobile device.

A computer readable non-transitory storage medium for storing computer executable instructions that when executed implement a method stored on a processor for executing the instructions of: transmitting to an apparatus that hosts a digital wallet, data concerning a purchase in a form so that a merchant generates a digital receipt content, wherein the digital receipt has data fields that permit the digital receipt to be stored for retrieval; and using a mobile device, manipulating data from the data fields using at least one application available to the mobile device that permits the data in the data fields to be selectively re-organized for presentation on the mobile device.

### BRIEF DESCRIPTION OF THE DRAWINGS

FIG. 1 is block diagram of system for implementing an exemplary embodiment of the present disclosure.

FIG. 2 is a flow chart representing the manner in which the system of FIG. 1 operates.

FIG. 3 depicts a screen from a mobile device that shows a content menu for the system according to the present disclosure.

FIGS. 4a through 4c depict screens for creating and selecting a transaction using the system of the present disclosure.

FIG. 5a depicts a screen showing a payment screen for an electronic payment for a transaction using the system of the present disclosure.

FIG. 5b depicts a screen showing a confirmation of an electronic payment for a transaction.

FIG. 5c depicts a screen having fields for entering category and vendor information regarding a transaction.

FIG. 5d depicts a screen showing a picture taken of a receipt of a transaction.

FIG. 5e depicts a screen showing a frame of a video taken during a transaction using the mobile device according to the present disclosure.

FIG. 6 depicts a screen showing fields for entering ranges for analyzing and filtering transactions, according to the present disclosure.

FIGS. 7a through 7d depict screens for creating a parental control in the form of a spending limit, according to the present disclosure.

FIG. 8 depicts a screen used for a manual transaction, according to the present disclosure.

A component or a feature that is common to more than one figure is indicated with the same reference number in each figure.

### DESCRIPTION OF THE PREFERRED EMBODIMENT

Referring to the drawings and, in particular, FIG. 1, there is shown a server generally represented by reference numeral 100. Server 100 is depicted in the cloud 120, and is configured to act as a part of a digital wallet service for mobile applications. Server 100 is connected to the Internet 120 by an interface 122. Server 100 includes a data processor 102, a memory 104, and an interface 112. Server 100 is connected to a display 116 and a keyboard 118, such as a computer/interface. Server 100 may have a plurality of other peripheral devices customarily found in any computer, such as, for example, a CD or DVD drive (not shown) for placing programs on the server or for creating physical records of data processed by the server.

Memory 104 has a memory portion 106 for an operating system (“OS”) for server 100, and a memory portion 108 for one or more application programs, including one that is the subject of this disclosure. Memory 104 also has a memory portion 110 used as the storage device for a database.

The data of the database 110 can be stored in any type of memory, including a hard drive, a flash memory, a CD, a RAM, or any other suitable memory, preferably with provisions for suitable backup. Such suitable backup provisions or devices are well known in the art.

User computers 125A to 125N can access server 100 via a connection to the Internet 122. Computers 125A to 125N can each have an application/interface providing digital wallet capability.

A mobile device 130, as shown in FIG. 1, has a display 140, and a memory 145 for storing an operating system 150 and a series of applications or applets therein. The series of applications or applets may include applets or application programs (hereinafter “an application”) 160 for use with the exemplary embodiment described herein. Mobile device 130 may access server 100 via an Internet connected Wi-Fi hot spot 162 (or by any telephone network, such as a 3G or 4G system, on which connected mobile device 130 communicates, by using application 160. Application 160 includes or connects with a digital wallet capability so that Internet purchases are quickly and easily completed for subsequent organization and categorization by the user of mobile device 130. The digital wallet functionality for making purchases may also reside in the internet and the browser of the connected device is the application that allows access to the wallet functionalities.

Purchases can be made by a consumer using a computer 125A to 125N, or mobile device 130, or swiping a payment card linked to a digital wallet. Mobile device 130 can communicate with a merchant's POS terminal 170 via NFC, QR code, Bluetooth, or manual token code, to make a purchase. However, NFC is preferred. POS terminal 170 has general POS capabilities including the ability to swipe a payment card (credit, debit or prepaid). POS terminal 170 is connected to a payment network 180, or to applicable payment middleware at the merchant's system, to allow the merchant to send information supplied by application 160, with its digital wallet capability, to payment network 180, so that the merchant is paid. The user's account will supply information concerning the location of the user's digital wallet in the cloud, so that contents of a receipt may be sent to the digital wallet.

Server 100 may also receive information from payment network 180. Payment network 180 may supply information as to which account was charged and the amount charged or other details of the purchase that can be combined with the receipt data received from the merchant.

On line purchases can also be made by using an Internet connected device, such as one of computers 125A to 125N or mobile device 130, connected to a merchant web site 190. Merchant web site 190 is connected to payment network 180, and purchases can be processed using a digital wallet.

The user uses one of computer 125A to 125N (or mobile device 130) to make a purchase online or at a POS. In particular, mobile payment organization capable application 160 can be used to facilitate the purchase via computer 125A to 125N or mobile device 130. Referring to flow chart in FIG. 2, application 160 of FIG. 1 is used to enter a trip name 200 to identify a transactions associated with the trip or to identify the trip for further use and reference. At 210, user uses the application to make a purchase, such as at a restaurant.

Payment information (or a payment token) is then communicated at 220 to the merchant from one of computers 125A to 125N or from mobile device 130. This information is preferably encrypted for the protection of user during usage. Payment information includes, but is not limited to, the address or location of the payer's digital wallet where the digital receipt shall be sent. This address or location may be expressed as a unique URL. Payer's digital wallet location/ID may also reside at the merchant's customer records (such as loyalty program or customer database etc.) and may be found there in addition to or in place of the payment method. The user or customer should have the option opt in/out for using the merchant provided facility.

Payment information is communicated as customary for electronic payments. The method to receive digital receipts relies on all current and regular methods for secure payments. The additional element included is the communication of user's digital wallet address/identifier (e.g. a URL) where the digital receipt shall be sent when the payment is made.

Referring again to FIG. 2, the merchant accesses the payment system at 230 so that user information is provided by the merchant apparatus to the payment system 180 of FIG. 1. The appropriate user account is accessed at 240 and is debited in the amount required for the purchase. The digital wallet operated on server 100 may have access and be linked to more than one of the user's accounts, such as, for example, different credit card accounts, so that the user can decide which account to use for a particular purchase. The user's account will confirm the amount that has been charged due to the transaction, and will send a debit note to the user's digital wallet 250. User's electronic payment details include the address of the user's unique digital wallet address (URL) in a dedicated payment data field. The merchant generates the digital receipt content using information from the user's digital wallet 260.

The receipt is stored 270 in the portion of memory 110 that contains the database for the mobile payment organization application 160 in memory portion 108 of server 100 and thus in cloud 120. The receipt will always be available to the user to recall from cloud 120. Thus, paper receipts are not required. The receipt stored on server 100 in cloud 120 has the advantages of never being lost and always available for subsequent analysis. Thus, the receipt can be used to organize expenses and categorize expenses for later use.

Upon completion of a successful transaction, the user has the option of performing several functions with regard to the POS and the receipt that has been stored. For, example, after step 270, mobile device 130 can have a GPS capability that allows logistical information regarding the vendor name, city, state, zip code, longitude and latitude to be saved with the receipt at 280. By saving the specific information regarding the location of the vendor or establishment, the user can have the option of re-visiting the vendor at a later time or informing others of the location.

Further, the mobile payment organization application 160 and mobile device 130 may have additional capability that has particular utility at the POS. For example, the user may wish to take a picture 290 of the actual receipt so that the receipt is never lost. Further, the user may wish to take a video 300 while at the establishment, such as a restaurant, to inform others of an opinion of a purchase or a dining experience. Videos can be recorded as part of each transaction during a trip. Optionally, a transaction can be categorized, re-categorized, or filtered as discussed below.

Referring again to FIG. 1, the data representative of the digital receipt is stored in database portion 110 of memory 104 in a series of fields. Preferably, the data is stored in a standard, text searchable format, which is actionable. Actionable as used herein means that the data can be retrieved, read or manipulated so that the data can be used, compiled or analyzed in any manner required, and if desired can be displayed in any format as a graph, animation, report or in any other user perceivable format. Further, memory 104 may have an underlying database program that allows a user to, for example, search for a particular entry or classify receipts or arrange or group receipts, and thus various reports can be generated.

Referring again to FIG. 2, the user of the application 160 on server 100 may find it advantageous to have the opportunity to tag and categorize 310 the digital receipt in some way both automatically and manually. While a merchant code may provide adequate information, there are situations in which a user desires to tag items in different types of transactions made during a trip, such as, for example, business expenses or personal expenses or make other annotations. The user may also wish to indicate that the transaction is a business transaction and is tax deductible. The use could indicate whether the transaction is related to food, lodging, airfare, transportation/gas, or entertainment. The ability to categorize transactions during a trip will help the user manage and separate personal and business expenses.

The actionable nature of the database permits the transactions to be edited 320 by the user. The user may wish to change the vendor or the category, or take an updated picture of the receipt to have for records. To assist the user, the database can also be filtered 330 by criteria such as category, date, state, city, vendor, tax deductible status for report generation. Once a particular criterion is selected, the filter will list all transactions that apply to that criterion along with a total of those transactions.

An application (or tag) 160 can be used to manually facilitate the purchase via computer 125A to 125N or mobile device 130. For example, if a vendor does not have Paypass™ capability or other electronic means of processing payment, the transaction can be added manually and still be categorized appropriately. Further, if a child of the owner of the computer 125A to 125N or mobile device 130 uses the device, the owner or parent can limit the amount of spending.

Referring to FIGS. 3 through 8, an exemplary use of the system according to the present disclosure will be described in reference to screens depicted in the referenced figures. Referring to FIG. 3, a user from a home screen selects the context menu 300 and selects an application from mobile screen user interface in a known fashion. Context menu 300 shows various selections that can be made such as Account Settings, Settings, Manual Transactions and Trip Transactions, Card Details, and Parental Controls. User may select Trip Transaction from context menu 300 to create a trip or transaction name to be entered at FIG. 4a, at screen 400. In FIG. 4a, user enters the name of the transaction or trip, such as the city “Chicago” to label the trip for future reference. Alternatively, user may select an existing trip at FIG. 4b at screen 405. In FIG. 4c, user saves or deletes a trip, at screen 410.

In FIG. 5a, a payment screen 505 is presented with a button for the user to press to pay for a meal, for example. After payment for the meal is successfully completed, post-payment screen 510 is shown in FIG. 5b. Upon completion of a successful payment, the user can click the add button in post-payment screen 510 to add categories, denote a transaction as being tax deductible, or take a picture or video.

FIG. 5c shows a screen 515 having fields for entering or editing the category of the transaction. Categories may be selected from several categories, such as food, lodging, airfare, transportation, entertainment, gas, per diem, or other business expenses. User may also enter the vendor name. Screen 515 contains a button 516 for taking a picture of a receipt or of the establishment, as shown in FIG. 5d. In screen 515, button 517 may be selected for taking a video while in the establishment, as shown in FIG. 5e. Button 518 may be selected for saving the various selections or entries made using screen 515.

Referring to FIG. 6, the user can filter transactions by category date, state, city, vendor, tax deductible status, presence of a receipt or video, at screen 600. After filter criteria are entered, mobile device 130 will list all of the trips or transactions that apply to those criteria.

Referring again to FIGS. 3 and 7a through 7d, a user may select Parental Controls button from the context menu 300 and enter a password and budget, and save the password and budget at screen 700 (FIG. 7a). The parental control feature is set in FIG. 7b, at screen 705. When the child is about to make a purchase, a remaining balance is shown at FIG. 7c, at screen 710. Should the child exceed the preset budget, an indication would be presented on the screen and the child would not be able to make the purchase, as shown in FIG. 7d at screen 715.

Referring again to FIG. 3, the user may select a manual transaction at an establishment if the establishment does not have a PayPass™ function using the context menu 300. The transaction amount is entered in FIG. 8, at screen 800.

There are numerous advantages offered by the disclosed exemplary embodiment. When using mobile payment organization system application 160 of mobile device 130, the customer always receives a digital (electronic) receipt when a purchase is made, either online or at a POS. The receipt is in a standard format. Any account used to make purchases can link the purchases to the user's digital wallet service 100 in cloud 120. The receipts are stored in cloud 120, where the receipts are always available for retrieval and for other uses. The user has access to all receipts from the user's mobile and online devices, and can utilize various types of analytics to review personal and business purchasing data for subsequent trips or for business purchases. This information can be collected and stored based upon vendor or establishment location when a purchase or transaction takes place using mobile device 130. The functionality of the application is particularly useful for travelers and for business travelers, in particular. The loss of receipts and forgotten locations can result in losses to the individual during business travels. The ability to group transactions based upon their date amount, location and tax deductible status is useful to business travelers to keep track of expenses and for generation of reports.

By using the system and method described herein, traveling can become a truly paperless endeavor. A receipt is always available. The receipt cannot be stolen or misplaced. User's purchases are linked to his/her digital wallet account where receipts are sent and stored. The user may organize and re-categorize and filter data into valuable and usable forms that are presented on mobile device 130.

Various approaches, technologies and pathways can be used to access server 100. In general, the Internet can be used. Access may be granted to a home or a business computer, including a desk top, lap top, or notebook computer; a personal digital assistant or any other Internet connected device, such as a tablet (for example, a device such as an iPad). Server 100 management can be done through a private access (intranet, VPN) for greater security.

It will be understood that the present disclosure may be embodied in a computer readable non-transitory storage medium. The medium stores instructions of a computer program that when executed by a computer system results in performance of steps of the method described herein. Such storage media may include any of those mentioned in the description above.

The terms “comprises” or “comprising” are to be interpreted as specifying the presence of the stated features, integers, steps or components, but not precluding the presence of one or more other features, integers, steps or components or groups thereof.

It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

1. A system for organizing electronic mobile payment transactions using a mobile device that uses electronic payment systems utilizing a digital wallet to make payments to a merchant, the system comprises:
an apparatus for hosting the digital wallet;
a first communication channel for communication of a location of the payer's digital wallet as a destination where a receipt shall be sent;
a second communication channel for transmitting data concerning a purchase to the apparatus so that a merchant generates contents of a digital receipt that has data fields so that data can be stored for retrieval; and
at least one application available to the mobile device that permits the data in the data fields to undergo data processing to be manipulated by a user of the mobile device for presentation on the mobile device.

2. The system according to claim 1, wherein the apparatus is a cloud based server.

3. The system according to claim 1, wherein the digital receipt is in a standard, test and field searchable format.

4. The system according to claim 1, wherein the at least one application permits the user to capture a picture of a receipt of a transaction or a plurality of transactions made at the location.

5. The system according to claim 1, wherein the at least one application permits the user to assign a category to a transactions made at a location by category.

6. The system according to claim 5, wherein said category is selected from the group consisting of food, lodging, airfare, transportation, entertainment, gas, per diem, and business expenses.

7. The system according to claim 1, wherein the at least one application permits the user to store transactions related to a plurality of locations.

8. The system according to claim 1, wherein the at least one application permits the user to organize the transactions based upon location or category.

9. The system according to claim 1, wherein the at least one application permits the user of the mobile device to store and retrieve geographical positioning system coordinates of the location.

10. The system according to claim 1, wherein said at least one application permits the user to capture a picture of a receipt of a transaction and to store a copy of the picture of the receipt.

11. The system according to claim 1, wherein said at least one application permits the user to capture video of the location by the user of the mobile device.

12. The system according to claim 1, wherein said at least one application permits the user to enter a password and a monetary amount, wherein said monetary amount represents a purchasing limit for a transaction using the mobile device.

13. A method for organizing electronic mobile payment transactions using a mobile device that uses electronic payment systems utilizing a digital wallet to make payments to a merchant, the method comprising:
transmitting to an apparatus that hosts the digital wallet, data concerning a purchase so that the merchant generates a digital receipt, wherein the digital receipt has data fields that permit the digital receipt to be stored for retrieval; and
manipulating data from the data fields using at least one application available to the mobile device that permits the data in the data fields to be selectively re-organized for presentation on the mobile device by a user of the mobile device.

14. The method according to claim 13, wherein the apparatus is a cloud based server.

15. The method according to claim 13, wherein the digital receipt is in a standard, test and field searchable format.

16. The method according to claim 13, wherein the data fields are configured for containing data representing a purchased good or service of the transaction.

17. The method according to claim 13, wherein the at least one application permits the user to assign a category to a transaction made at a location.

18. The method according to claim 17, wherein the category is selected from the group consisting of food, lodging, airfare, transportation, entertainment, gas, per diem, and business expenses.

19. The method according to claim 13, wherein the at least one application permits the user to: store transactions related to a location or a plurality of locations; organize the transactions based upon location or category; store and retrieve geographical positioning system coordinates of a location or a plurality of locations; capture a picture of a receipt of a transaction or transactions made at a location; capture a picture of a receipt and to store a copy of a picture of the receipt; capture video of a location by the user of the mobile device; and/or enter a password and a monetary amount, wherein the monetary amount represents a purchasing limit for a transaction using the mobile device.

20. A computer readable non-transitory storage medium for storing computer executable instructions that when executed implement a method stored on a processor for executing the instructions of a method, the method comprising:
transmitting to an apparatus that hosts a digital wallet, data concerning a purchase so that a merchant generates a digital receipt, wherein the digital receipt has data fields that permit the digital receipt to be stored for retrieval; and
manipulating data from the data fields using at least one application available to a mobile device that permits the data in the data fields to be selectively re-organized for presentation on the mobile device by a user of the mobile device.
